(19) United States
(12) Patent Application Publication
(10) Pub. No.: US 2002/0141202 A1
(43) Pub. Date: Oct. 3, 2002

(54) Embedde light guide plate for a flat panel display and method for makking the same

(75) Inventors: Chen-Hua Liu, Taipel (TW); Jui-Chuan Chang, Taipei City (TW); Guang-Tau Sung, Feng-Yuan City (TW)

Correspondence Address: BACON & THOMAS, PLLC, 625 SLATERS LANE, FOURTH FLOOR, ALEXANDRIA, VA, 22314

(73) Assignee: AU Optronics Corp., Hsinchu City (TW)

(21) Appl. No.: 10/107,456

(22) Filed: Mar. 28, 2002

(30) Foreign Application Priority Data
Mar. 28, 2001 (TW) 90107423

(51) Int. Cl. G02F 1/1335

(52) U.S. Cl. 362/558

(57) ABSTRACT

A light guide plate with embedded diffuser sheet is disclosed. The light guide plate for a flat panel display device, includes: a bottom substrate having a cross-section of trapezoid for transferring and reflecting said light; and a diffuser sheet locating on the substrate to distribute the light; wherein said diffuser sheet is integrated with said substrate. The light guide can reduce the thickness and the weight of a backlight module used for a flat panel display device.

### BACKGROUND OF THE INVENTION

1. Field of the Invention

The present invention relates to a light guide plate and, more particularly, to a light guide plate for a flat panel display device and a method for manufacturing the light guide plate.

2. Description of Related Art

Currently, since liquid crystal panels cannot emit light themselves, liquid crystal displays uses backlight module and light source to provide brightness for displaying. The backlight module is used to distribute the light homogeneously over the active area of the liquid crystal display panels (or other flat panel display devices). A traditional backlight module (as shown in FIG. 1A) is a combination of a light guide plate 110, a first diffuser sheet 120, a first prism sheet 130, a second prism sheet 140, and a second diffuser sheet. 150. Most of the time, the light guide plate used in the traditional backlight module is a substrate with a cross-section of trapezoid. Another prismless combination of the backlight module (as shown in FIG. 1B) includes a first diffuser sheet 180, a first prism sheet 170 and a prism-embedded light guide plate 160. The thickness of the traditional backlight modules (as shown in FIG. 1A) is great for the flat panel display device. On the other hand, although the thickness of the prismless backlight module (as shown in FIG. 1B) is less. However, since there is only one diffuser sheet is used, the half-luminance angle is not increased greatly enough to enhance the brightness of the active area of the liquid crystal display panels (or other flat panel display devices).

On the other hand, the customers need a backlight module with less thickness, less weight and enough or greater half-luminance angle. To cope with the trend of the market, the thickness and the weight of the backlight module needs to be improved.

Therefore, it is desirable to provide an improved light guide plate for the flat panel display device to mitigate and obviate the aforementioned problems.

### SUMMARY OF THE INVENTION

The object of the present invention is to provide a thinner embedded light guide plate for decreasing the thickness and the weight of a backlight module, and for increasing the half-luminance angle of the light guide plate.

Another object of the present invention is to provide a method for manufacturing a light guide plate to reduce the thickness and the weight of the light guide plate and to increase the half-luminance angle of the light guide plate.

To achieve the object, the embedded light guide plate for a flat panel display device, comprising: a bottom substrate having a cross-section of trapezoid for transferring and reflecting said light; and a diffuser sheet locating on the substrate to distribute the light; wherein said diffuser sheet is integrated with said substrate.

The method for manufacturing light guide plate, comprising following steps: (A) providing a bottom substrate having a cross-section of trapezoid for transferring and reflecting said light; (B) forming and fixing a diffuser sheet on said bottom substrate; and optionally (C) providing a top substrate and combing said top substrate with said bottom substrate and said diffuser sheet.

Other objects, advantages, and novel features of the invention will become more apparent from the following detailed description when taken in conjunction with the accompanying drawings.

### BRIEF DESCRIPTION OF THE DRAWINGS

FIG. 1A and FIG. 1B is a perspective view of an assembly of the conventional backlight module.

FIG. 2 is a perspective view of one embodiment of the light guide plate of the present invention in an assembly of the backlight module having.

FIG. 3 is a perspective view of another embodiment of the light guide plate of the present invention in an assembly of the backlight module having.

FIG. 4 is a perspective view of the process for manufacturing the light guide plate of the present invention.

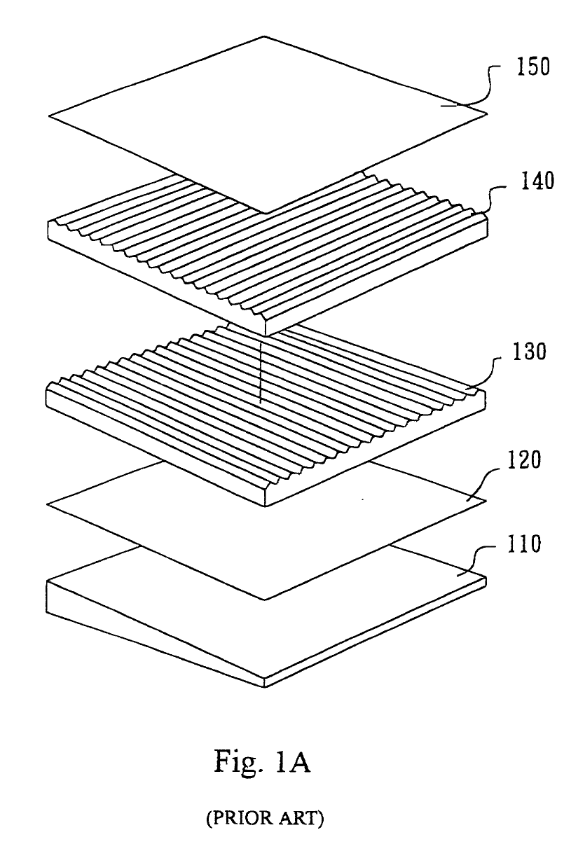

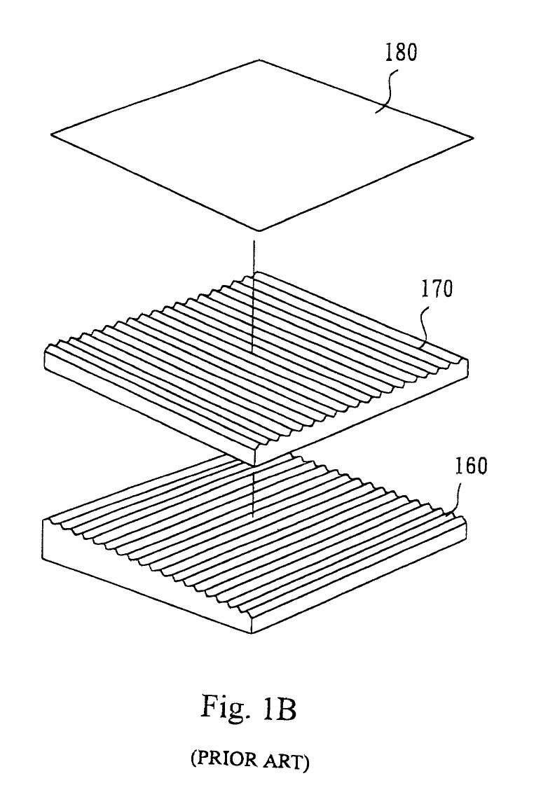

### DETAILED DESCRIPTION OF THE PREFERRED EMBODIMENT

The light guide plate of the present invention can be used for any flat panel display device. Preferably, the light guide plate of the present invention is used for liquid crystal display devices. The substrate used here can be any conventional substrate used for light guide plate. The light guide plate of the present invention can selectively further includes a top substrate. The top substrate is settled on the diffuser sheet and the bottom substrate of the light guide plate. The top substrate of the light guide plate of the present invention can be any conventional substrate used for the light guide plate. Preferably, the top substrate of the present invention is a substrate having a surface with a smooth plane, micro lens or grating grooves. The diffuser sheet of the present invention can locate on the surface of the bottom substrate or sandwiched between the top substrate and the bottom substrate. In other words, the diffuser sheet can be integrated with the light guide plate. The method for embedding the diffuser sheet into the light guide plate can be any conventional method. Preferably, the diffuser sheet is integrated on the bottom substrate or between the bottom substrate and the top substrate by transferring-printing, adhering, thermal melting or coating. The diffuser sheet can use any conventional method to locate or transfer to the position on the bottom substrate for combining. Preferably the diffuser sheet is located on the position for combining through the help of a continuous conveyor. The formation of the light guide late can use any conventional process. Preferably, the formation of the bottom substrate and top substrate is achieved through injection molding. Most preferably, the formation of the top substrate is through a second injection molding after the first injection molding of the bottom substrate is achieved.

The light guide plate of the present invention can combine with a first prism sheet, optionally a second prism sheet and another diffuser sheet to form a backlight module.

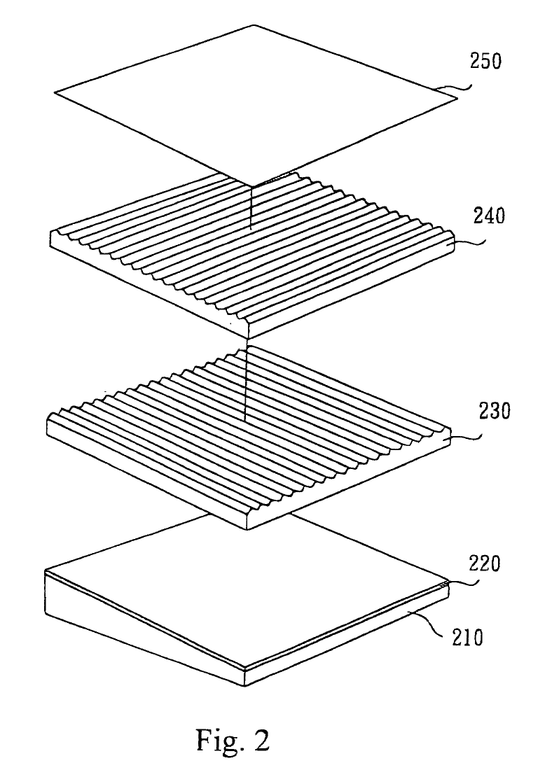

With reference to FIG. 2, there is shown an embedded light guide plate for a backlight module or for a flat panel display of the present invention. The backlight module in FIG. 2 includes two prism sheets, a diffuser sheet and a light guide plate of the present invention. The light guide plate of the present invention includes a bottom substrate 210 and a diffuser sheet 220. The bottom substrate 210 used here is a substrate having a cross-section on a shape of trapezoid. The diffuser sheet 220 locates on the surface of the bottom substrate. The diffuser sheet 220 is also integrated with and embedded in the bottom substrate 210. The light guide plate of the present embodiment can be made as thick as the conventional light guide plate. The total thickness of light guide plate of the present embodiment can also be designed to be less than that of the conventional light guide plate. Moreover, since the diffuser sheet is embedded in the light guide plate of the present embodiment, the light guide plate is a light guide plate having the function of a diffuser sheet. The thickness of the light guide plate of the present embodiment can be set as same as or less than that of the conventional light plate. As the light guide plate of the present embodiment is used in the backlight module, only additional one diffuser sheet and two prism sheets are needed for the backlight module because the light guide plate can also function as a diffuser sheet. This kind of light guide plate with embedded diffuser sheet can decrease the total thickness of a backlight module since the thickness of a diffuser sheet can be reduced in the backlight module of a flat panel display device. As show in FIG. 2, as the light guide plate of the present embodiment is assembled with first prism sheet 240, second prism sheet 230 and another diffuser sheet 250, the total thickness or the weight of a backlight module is reduced. Compared with the conventional light guide plate or the conventional backlight module, the decrease of weight and total thickness is obvious. Besides, as used in the backlight module, the cooperation of the embedded diffuser sheet in the light guide plate and the additional diffuser sheet still increases the half-luminance angle effectively.

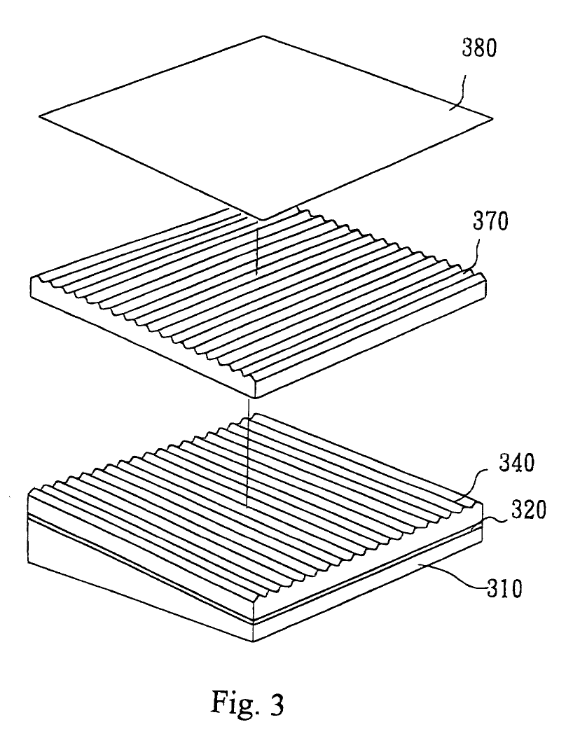

With reference to FIG. 3, there is shown second embodiment of the light guide plate of the present invention. The backlight module in FIG. 3 also includes two prism sheets, a diffuser sheet and a light guide plate of the present invention. The light guide plate of the present invention includes a top substrate 340, a bottom substrate 310 and a diffuser sheet 320. The bottom substrate 310 used here is a substrate having a cross-section on a shape of trapezoid. The diffuser sheet 320 is sandwiched between the top substrate 340 and the bottom substrate 310. The top substrate used in the present invention can be a substrate having a surface of a smooth plane surface, a plurality of grated grooves as a prism sheet, or micro lens. In the light guide plate of the present embodiment, the top substrate is a substrate with a surface having grated grooves. In other words, a diffuser sheet and a prism sheet is integrated with and embedded in the light guide plate of the present embodiment. Compared with conventional light guide plate of a backlight module, the light guide plate of the present embodiment has more functions. More over, the light guide plate of the present embodiment can be made as thick as the conventional light guide plate. The total thickness of light guide plate of the present embodiment can also be designed to be less than that of the conventional light guide plate. Since the diffuser sheet and the prism sheet is embedded in the light guide plate of the present embodiment, the light guide plate is a light guide plate having the function of a diffuser sheet and a prism sheet. The thickness of the light guide plate of present embodiment can be set as same as or less than that of the conventional light plate. As the light guide plate of the present embodiment is used in the backlight module, only additional one diffuser sheet and one prism sheet are needed for the backlight module because the light guide plate of the present embodiment can also function as a diffuser sheet and a prism sheet. This kind of light guide plate with embedded diffuser sheet can decrease the total thickness of a backlight module since the thickness of a diffuser sheet and a prism sheet can be reduced in the backlight module of a flat panel display device. As show in FIG.3, as the light guide plate of the present embodiment is assembled with prism sheet 370 and a diffuser sheet 380, the total thickness or the weight of a backlight module is reduced. As light goes through the light guide plate of the present embodiment, the light is diffused twice to increase the half-luminance angle. In other words, the function of the backlight module to increase the half-luminance angle still remains. However, compared with the conventional light guide plate or the conventional backlight module, the weight and the total thickness of the light guide plate or the backlight module of the present embodiment decrease a lot.

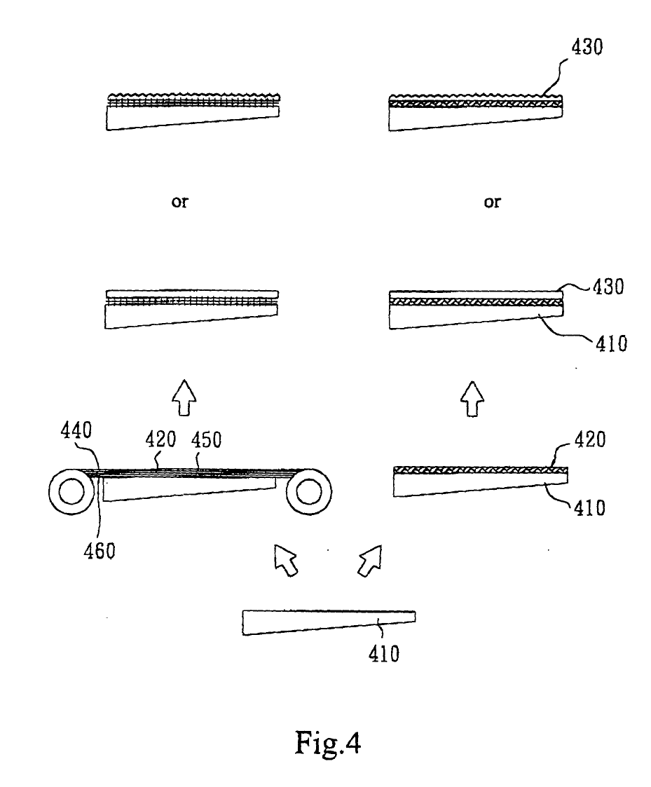

The embedded light guide plate of the present invention can be made by injection molding. The bottom substrate 410 can be made through first injection molding. The diffuser sheet forms on the surface of the bottom substrate 410 subsequently. Finally, the top substrate 430 (top substrate having prism or micro lens) forms on the diffuser sheet 420 through second injection molding. The diffuser sheet 420 can be formed on the surface of the bottom substrate 410 through continuous transferring-printing (as shown in FIG. 4). In FIG. 4, the diffuser sheet 420 is settled on a conveyer having a PET film 440, a release layer 450 and an adhesive layer 460. The diffuser sheet 420 is sandwiched between the release layer 450 and the adhesive layer 460 before the formation on the bottom substrate. The release layer 450is sandwiched between the diffuser sheet 420 and the PET film 440 (the conveyor). As the diffuse sheet 420 comes to the right position for forming on the bottom substrate 410 by the assistance of the conveyor, knives cuts the diffuser sheet 420 and the diffuser sheet 420 is combined with the bottom substrate 410 through thermal melting.

Although the present invention has been explained in relation to its preferred embodiment, it is to be understood that many other possible modifications and variations can be made without departing from the spirit and scope of the invention as hereinafter claimed.

What is claimed is:

1. An embedded light guide plate for a flat panel display device, comprising:
a bottom substrate having a cross-section of trapezoid for transferring and reflecting light; and
a diffuser sheet locating on the substrate to distribute the light;
wherein said diffuser sheet is integrated with said substrate.

2. The embedded light guide plate as claimed in claim 1, further comprising a top substrate locating said bottom substrate, wherein said diffuser sheet is sandwiched by said top substrate and said bottom substrate.

3. The embedded light guide plate as claimed in claim 1, wherein said top substrate is a substrate having a smooth plane, micro lens or grating grooves.

4. The embedded light guide plate as claimed in claim 1, wherein said diffuser sheet is sandwiched between said bottom substrate and said through thermal melting.

5. The embedded light guide plate as claimed in claim 1, wherein said diffuser sheet is sandwiched between said bottom substrate and said top substrate through transferring printing.

6. A method for manufacturing light guide plate, comprising following steps:
(A) providing a bottom substrate having a cross-section of trapezoid for transferring and reflecting said light;
(B) forming and fixing a diffuser sheet on said bottom substrate; and optionally
(C) providing a top substrate and combing said top substrate with said bottom substrate and said diffuser sheet.

7. The method as claimed in claim 6, wherein said top substrate is a substrate having a smooth plane, micro lens or grating grooves.

8. The method as claimed in claim 6, wherein said top substrate is formed through injection molding.

9. The method as claimed in claim 6, wherein said top substrate is formed through second injection molding after said diffuser is formed on said bottom substrate.

10. The method as claimed in claim 7, wherein said bottom substrate is made through injection molding.

11. The method as claimed in claim 7, wherein said diffuser sheet is formed on said bottom substrate and said through thermal melting.

12. The method as claimed in claim 7, wherein said diffuser sheet is formed on said bottom substrate and said through transferring printing.

13. A backlight module for a flat panel display device, comprising:
a first diffuser sheet;
a first prism sheet;
a second prism sheet; and
an embedded light guide plate as claimed in claim 1.

14. A backlight module for a flat panel display device, comprising:
a first diffuser sheet;
a first prism sheet;
a second prism sheet; and
an embedded light guide plate as claimed in claim 2.

15. The backlight module as claimed in claim 14, wherein said top substrate is a substrate having a smooth plane, micro lens or grating grooves.

16. The backlight module as claimed in claim 14, wherein said said diffuser sheet is sandwiched between said bottom substrate and said through thermal melting.

17. The backlight module as claimed in claim 14, wherein said said diffuser sheet is sandwiched between said bottom substrate and said top substrate through transferring printing.
